(19) United States
(12) Patent Application Publication
(10) Pub. No.: US 2011/0066472 A1
(43) Pub. Date: Mar. 17, 2011

(54) Internet-Based Benchmarking System and Method for Evaluating and Comparing Businesses Using Metrics

(76) Inventor: Pedro Cabrera Scheider, Weston, FL (US)

(21) Appl. No.: 12/561,365

(22) Filed: Sep. 17, 2009

(51) Int. Cl. G06Q 10/00

(52) U.S. Cl. 705/10

(57) ABSTRACT

A system and method for evaluating and comparing businesses and, more specifically, to an Internet-based benchmarking or management tool or platform that provides one or more metrics by which a business owner may anonymously track, evaluate and compare the relative condition of its business with other similarly situated businesses of the same or related type whereby the one or more metrics are based upon the business' quantifiable data (e.g., profits, movement of inventory, etc) that is indicative of the business' operations such that a business owner may implement improvements to the business' operations in response to the information provided.

### FIELD OF THE INVENTION

This invention relates in general to a system and method for evaluating and comparing businesses and, more specifically, to an Internet-based benchmarking tool or platform that provides one or more metrics by which a business owner may anonymously track, evaluate and compare the relative condition of its business with other similarly situated businesses of the same or related type whereby the one or more metrics are based upon the business' quantifiable data (e.g., profits, movement of inventory, etc.)

### BACKGROUND OF THE INVENTION

In order to maintain a truly successful business, it is helpful for business owners and management teams to have a single source that provides an easily accessible framework for a meaningful and realistic evaluation and ranking of their own business that may be used to compare the relative financial condition and market position of their business to other similarly situated businesses of the same or related type. Such a framework would allow a business to routinely perform a self-evaluation and determine how the business is operating in comparison with directly competing businesses or other similarly situated businesses. With this framework, a benchmark standard or mathematical frame of reference could be established by which a business may measure itself and efficiently manage, in real time, its business operations in order to improve its operations with respect to the specific mathematical indicators of the framework and to meet or exceed the benchmark standard. Furthermore, by being able to monitor the overall condition of the relevant industry and/or geographic sector, a business may be able to foresee and more easily predict any changes it should make in its operations and gather information from other businesses as to how to better manage its operations. Such a framework does not exist but would be a very useful consulting tool.

There currently exist a number of examples in which businesses within a particular industry are compared or rated in relation to one another. Oftentimes, these ratings are based upon the subjective opinion and experience of third-party industry experts or individual customers and not on quantifiable data. For instance, a number of surveys or reviews are published by food critics who rate and recommend various restaurants, within a certain geographic area or cuisine type, based upon a number of factors, including the taste and presentation of the food, the menu offerings, the freshness of the ingredients, the ambiance and service, etc. In another example, a number of hospitality experts publish travel guides that rate various hotels and resorts, based upon a number of factors relevant to that particular industry, such as the types of amenities provided, the quality of the architecture and the furnishings and textiles used inside the rooms, the value received for the price paid, the room and concierge service, etc. Although some of these ratings systems have long been established and recognized as setting standards within particular industries whereby businesses strive to obtain a certain rating, many of these systems are based upon unquantifiable factors and the subjective opinion of the reviewer. Therefore, a rating may not necessarily reflect or correlate with the financial health of the business and its operations. Consequently, it is difficult to use a particular rating to gauge the performance of a business' operations and therefore, these ratings systems are limited in their effectiveness as management tools. In addition, the majority of these ratings systems are targeted towards the end-consumer and do not provide a management system, database or publication with the type of information that is most useful for a business owner in managing the owner's business.

Other ratings systems exist in the prior art that do not primarily rely upon the subjective opinion of a reviewer and are purportedly based upon quantifiable data closely related to and indicative of a business' financial condition and operations. For example, a number of investment firms and financial analysts publish periodic lists or ratings of private and publicly offered businesses that are related to one another in size or by industry, etc. The lists or ratings systems are described as being based on a combination of factors, including, for example, net income, total sales, stock prices and stock performance relative to industry peers, return in equity, sales growth and profit growth over a certain period of time, debt to total capital ratios, etc. However, despite that these lists or ratings systems are closely associated with and more indicative of a business' operations than those systems that are based on subjective criteria, they are almost entirely based upon consolidated financial results that do not include a set of operative measurements or metrics by which a business can measure its efficiency and productivity and they are oftentimes not useful or relevant to most businesses for a number of additional reasons.

For example, typically, only a small number of businesses are chosen to be analyzed and rated and they are usually corporations that have nationwide sales and are publicly traded. Therefore, for most small and local businesses, it is meaningless and unreasonable to try to measure and compare their operations with the companies that are being rated.

Also, none of these lists or ratings systems provide an easily accessible and ongoing available framework for any type of business to perform a self-evaluation of the business using personal financial data in comparison with other similarly situated businesses of the same or related type. The evaluation and comparison is limited only to those companies that were chosen to be included in the list or ratings system and appear in that particular set of ratings or on that list. Currently, a framework does not exist that can be accessed by any business and used to determine that particular business' performance amongst a highly specific set of businesses that can be narrowly defined to include businesses of a particular industry that have a particular set of attributes, size and location.

Furthermore, although some of the ratings systems display the financial data of the corporations that are rated (e.g., sales, sales growth, earnings per share growth, etc.), the data is typically listed in the various categories as raw figures of consolidated financial results. There is no way to decipher how that data correlates into a metric that is used to establish the rating and the metrics are not related to the available resources such as space, personnel or inventory, which are specific to each business and are necessary to calculate the performance of a business. Therefore, there is no way for a business to identify what areas in which it is lacking in or needs to improve upon in order to achieve a specific rating.

In addition, most of these ratings systems and lists are published by third-party industry analysts and experts and not by the actual companies themselves. Thus, the lists or ratings systems are usually based only upon information that is required to be made public, which is limited in nature. Accordingly, there are a substantial number of privately held and small businesses that cannot be evaluated by the existing ratings systems. Furthermore, because the ratings systems reveal the identities of the businesses being rated, there is a significant disincentive for the businesses to share non-public and confidential information regarding their operations. As a result, because there is no cloak of anonymity and due to the fact that the lists or ratings are determined by third parties, there is a wealth of specific and useful information that is not being shared between businesses. There is no existing method or system for a business owner to satisfy his or her curiosity of how other businesses having the same business profile are truly performing with respect to a set of comparable measurements or metrics such that the business owner can determine what improvement actions can be implemented to achieve what is shown to be possible by comparable operations.

Therefore, a need exists to overcome the problems with the prior art as discussed above.

### SUMMARY OF THE INVENTION

Embodiments of the present invention provide a system and method for evaluating and comparing businesses, which includes inputting into an Internet-accessible portal one or more data figures that reflect the operations of a user's business wherein the portal has a user-interface, storing the one or more data figures in at least one database that is in communication with the portal, calculating one or more metrics that are based upon the one or more data figures and are indicative of the user's business operations, defining a group of one or more businesses that are similarly situated to the user's business and of which the one or more metrics are known and have been stored in the at least one database, assigning a metric ranking number to the user's business and to the one or more businesses of the group based upon the metrics, and displaying the metric ranking numbers of the user's business and the one or more businesses of the grouping in a format wherein their respective metrics can be compared against one another.

In accordance with another feature, an embodiment of the present invention includes requiring a password in order for a user to access the portal.

In accordance with another feature, an embodiment of the present invention includes the user's manual entry of the one or more data figures on a periodic basis.

In accordance with another feature, an embodiment of the present invention includes the automatic entry of the one or more data figures on pre-defined periodic basis.

In accordance with yet another feature of the present invention, the one or more data figures reflect the revenue, number of units sold, amount of inventory, physical dimensions and number of employees of the user's business during a period of time.

In accordance with yet another feature of the present invention, the one or more data figures reflect the customer satisfaction with the user's business during a period of time.

In accordance with yet another feature of the present invention, the identities of the user's business and the one or more businesses of the group are kept anonymous from one another.

In accordance with yet another feature of the present invention, at least one of the metrics is indicative of the performance during a period of time of the business about which the metric is calculated.

In accordance with yet another feature of the present invention, at least one of the metrics is indicative of the productivity during a period of time of the business about which the metric is calculated.

In accordance with yet another feature of the present invention, at least one of the metrics is indicative of the profits during a period of time of the business about which the metric is calculated.

In accordance with yet another feature of the present invention, at least one of the metrics is indicative of the customer satisfaction during a period of time with the business about which the metric is calculated.

In accordance with yet another feature of the present invention, the one or more metrics are dependent upon the type of business about which the metric is calculated.

In accordance with another feature, an embodiment of the present invention includes displaying the metric ranking numbers in a series of one or more comparison tables.

In accordance with yet another feature, an embodiment of the present invention includes having each of the one or more comparison tables in the series correspond to a metric.

In accordance with another feature of the present invention, the one or more data figures relied upon to calculate the metric is also displayed in the comparison table.

In accordance with yet another feature of the present invention, the one or more metrics are calculated after each period that the user enters the one or more data figures.

In accordance with yet another feature of the present invention, the user defines the group of the one or more businesses based upon one or more characteristics that include the type of business department, physical size, geographical location of the one or more businesses and other industry-specific attributes.

In accordance with yet another feature of the present invention, the user specifies a period of time over which the calculation of the one or more metrics is to reflect.

In accordance with yet another feature of the present invention, the one or more comparison tables further comprises information that explains the definition and meaning of what is displayed in the one or more comparison tables.

In accordance with another feature of the present invention, the one or more comparison tables further comprises average or benchmark levels of the one or more metrics against which the user may compare the corresponding one or more metrics of the user's business.

In accordance with another feature, an embodiment of the present invention includes further comprising a means for the user and the one or more businesses of the group to anonymously communicate directly in order to exchange information as to the “best practices” relating to specific issues of operating a business.

Additional advantages of the present invention will be set forth in the Detailed Description which follows and may be understandable from the Detailed Description or may be learned by practice of exemplary embodiments of the invention. Still other advantages of the invention may be realized by any of the instrumentalities, methods or combinations particularly pointed out in the claims. Although the invention is illustrated and described herein as embodied in one or more exemplary embodiments, it is, nevertheless, not intended to be limited to the details shown because various modifications and structural changes may be made therein without departing from the spirit of the invention and within the scope and range of equivalents of the claims. The system and method of operation of the invention, however, together with additional objects and advantages thereof, will be best understood from the following description of specific embodiments when read in connection with the accompanying drawings.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a flow diagram illustrating a system and method for initially registering a user, according to an exemplary embodiment of the present invention.

FIG. 2 is a flow diagram illustrating a system and method for a user to periodically enter quantifiable data regarding the user's business into the system, according to an exemplary embodiment of the present invention.

FIG. 3 is a flow diagram illustrating a system and method for a user to consult the system to compare the user's business to one or more other businesses of a certain type, according to an exemplary embodiment of the present invention.

FIG. 4 is a flow diagram illustrating a system and method for a user to specify the characteristics of the one or more businesses that are to be compared with the user's business, according to an exemplary embodiment of the present invention.

FIG. 5 is a flow diagram illustrating a system and method for a user to view the rankings, in one or more metric, of the user's business in comparison to the rankings of one or more other businesses of a certain type, according to an exemplary embodiment of the present invention.

FIG. 6 is a flow diagram illustrating a system and method for calculating the “Performance” metric of a business, according to an exemplary embodiment of the present invention.

FIG. 7 is a flow diagram illustrating a system and method for calculating the “Productivity” metric of a business, according to an exemplary embodiment of the present invention.

FIG. 8 is a flow diagram illustrating a system and method for calculating the “Profit” metric of a business, according to an exemplary embodiment of the present invention.

FIG. 9 is a flow diagram illustrating a system and method for calculating the “Pleasure (Customer Satisfaction)” metric of a business, according to an exemplary embodiment of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Before the present invention is disclosed and described, it is to be understood that the terminology used herein is for the purpose of describing particular embodiments only and is not intended to be limiting. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

A website or other portal that is Internet-accessible is provided for each user to have easy access to and be able to use the system and method of the present invention. Each user can access the website or portal using any device that is capable of connecting to the Internet, such as a personal computer or PC. The website or portal is comprised of a user-friendly interface that is specific to the user's relevant industry and is in communication with one or more networks and one or more databases using a wired or wireless connection to the one or more networks and the one or more databases.

Users of the present invention include, but are not limited to, individual business owners and management officers or teams of public and private corporations that are willing to share data reflecting their finances and operations anonymously using the system and method of the present invention. The system and method of the present invention is applicable to all types of industry fields, and in particular, in industries where the resources of personnel, space and service quality are key factors in determining the success of the business. Examples of industry fields that could benefit from the system and method of the present invention include, but are not limited to, restaurants, automotive dealers, dentistry, medical and similar professional practices, real estate agencies, manufacturing and/or assembly factories, retail outlets, bakeries and pharmacies.

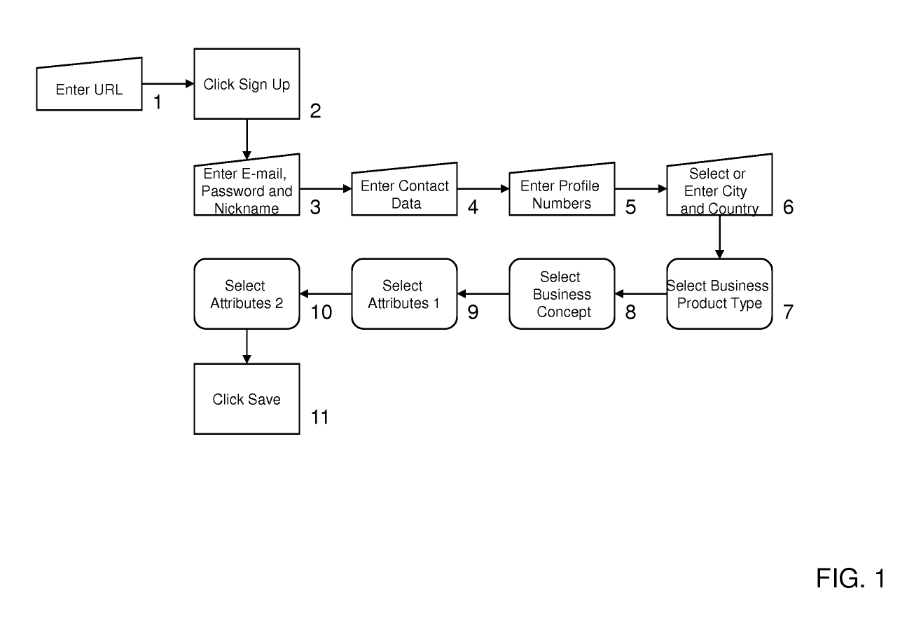

Referring now to the figures of the drawings in detail and first, particularly to FIG. 1 thereof, there is shown, according to a first exemplary embodiment of the present invention, a flow diagram of the system and method by which a user, for example, a business owner, can access the website or other portal and initially sign up/register the owner's business so that the business owner can utilize the larger system and method of the present invention. It is envisioned that the system and method may only be used after a user completes this registration process to ensure that only bona fide and auditable businesses can use the system and process. This registration is a one-time action for each business/user. It also envisioned that the user be required to enter into a user agreement (for example, an end-user license agreement) to gain access to the system and method of the present invention. Furthermore, it is contemplated that the system and method of the present invention act as a “Software as a Service” (i.e., SAAS) whereby the software implementation of the system and method of the present invention acts as an interactive service deployment for the user.

Initially, the user accesses the website or portal by, for example, entering 1 the URL address of the website. Once the user is directed to the website, a user-friendly interface is displayed and the user is prompted (e.g., “CLICK SIGN UP”) to create a password-protected user profile 2 by entering a unique alphanumeric identification code (e.g., the user's email address) and password 3. The identification code and password will be used by the user each time the user wants to access the system via the website or portal. In addition, to maintain anonymity of the user's business, the user is also required to enter an alias or a “nickname”, which will be publicly visible to the other users of the present invention. After the user has entered this initial information, the user is then required to enter a basic set of specific information 4, into one or more data entry fields, which identifies the user's business to the administrator of the system and method. For example, this information could include, but is not limited to, the corporate or company name of the business, the address and telephone number of the business and the name of the general manager and/or officers of the business. Also, it is preferred that the user be required to enter the tax identification number of the company so that the bona fide nature and authenticity of the business can be verified. This information will not be publicly visible or shared with other users and will be maintained as confidential.

After the user has entered this basic identifying information, the user is then required to enter further information, into one or more data fields, that characterizes and is indicative of the nature of the operations and the relative size of the user's business 5. For example, this information may include, but is not limited to, the business' sales revenue or units of output over the past year, the number of employees, the number of square meters or feet of different departments or areas of the business. Thereafter, the user may be required to enter or select the location 6 (e.g., block number, city, county, state and country), type of business or product type 7 and the business concept type 8 of the user's business. Once the user specifies the business concept type, the user may be given one or more categories of particular attributes 9, 10 that correspond to the business concept type that the user must select from to further define the user's business operations. For example, if the user owns a restaurant, the user may be asked to further define the restaurant by the type of cuisine (e.g., Italian, Japanese, Latin, etc.), the type of kitchen (e.g., fast food, gourmet, café, etc.), the operating shifts (e.g., breakfast, lunch, dinner, etc.) and whether the restaurant concept is primarily a take out, delivery or sit-down operation. After the user has completed entering all of the information necessary to create the user's password-protected profile, the user is prompted to save 11 the information into the system so that it may be stored in a searchable format in the one or more databases and can be further processed as described in detail below. In one exemplary configuration, once the information is stored into the system, the user receives a confirmation notice, for example, by email. This notice will indicate that the user has successfully registered the user's business with the system and will describe how the user is to provide operational figures or data periodically in order for the user to utilize the system and method of the present invention. For security purposes, it may be desirable for the confirmation notice to also include measures for the user to activate the user's business' password-protected profile.

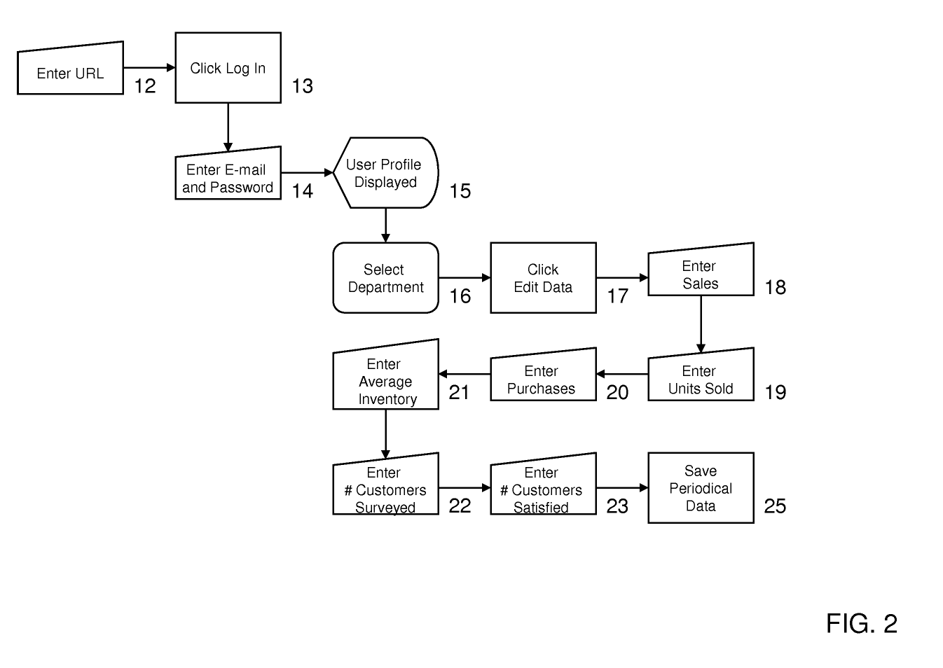

Referring to FIG. 2, it is necessary for the user to periodically report or enter quantifiable figures or data into the system that reflect the business' operations to allow the system and method to mathematically calculate and provide a set of metrics that the user may use to evaluate the condition of the business and to compare itself with other similarly situated businesses of the same or related type. The reporting period may be any period of time that is suitable for providing a meaningful benchmark for the user, which oftentimes varies depending on the reporting periods that are conventional to that user's type of business. For example, the duration of a sales period may be weekly, monthly, quarterly or yearly depending on how a particular business or industry is structured. The reporting period may be defined by the user or, in the alternative, may be predetermined or preset by the system. A wide range of types of figures or data may be entered. However, unlike most of the currently existing industry ratings systems, the figures and data entered are purely quantifiable, numerical and are objectively determined. The figures or data should be indicative of the financial conditions and operations of the business. The figures or data may also reflect the satisfaction of the business' customers.

To report or enter the quantifiable figures or data, the user enters the website or portal, for example, by going to the URL address 12 of the relevant website (which may be a website specific to a particular industry), and, using the identification code and password 13 that was set during the registration process (see FIG. 1), gains access 14 (e.g. “CLICK LOG IN”) to the system. Upon successful entry into the system, the user's profile is displayed 15 and the user is provided with a list or menu of business departments. From that list or menu, the user must select the appropriate business department 16 that corresponds to the type of business or area (department) that the user wants to analyze. For example, if the user is operating a restaurant, the user might select a department entitled “Food Department.” In another example, if the user is operating a car dealership, the user might select a department entitled “Mechanical Workshop” or “Automotive Department.” In yet another example, if the user is a dentist or a physician and has a private practice, the user might select a department entitled “Medical Practice Department” or “Cosmetic & Implant Dentistry.” In a further example, if the user is operating a clothing retail store, the user might select a department entitled “Retail Department.” According to the presently-described embodiment, once the user selects the appropriate business department, the user initiates the process of reporting or entering the quantifiable figures or data by selecting an option for editing the data 17 (e.g., “CLICK EDIT DATA”). In response to the user's prompt, the system displays a data entry screen having a plurality of data entry fields for the user to enter figures or data that are commonly collected and are customary to the type of business department of the user's business. For example, if the user's business is a retail store, the system may ask the user to enter weekly totals for the sales revenue 18, the number of units sold 19, the number of purchases made 20, the average inventory level at cost 21, the number of customers surveyed 22, and the number of customers surveyed who indicated that they were satisfied 23. Once the user completes the entry of the requisite figures or data, the user is prompted to save 25 the information into the system so that it may be stored in a searchable format in the one or more databases and used to calculate the one or more metrics that will serve as a basis for comparison. Alternatively, once the user understands how the figures or data entered by the user relate to the metrics that are calculated or determined by the system and method of the present invention as discussed in detail below, it is contemplated that the periodic entry of the figures or data may be configured to be automated. For example, an interface may be provided that connects the website with the user's local point of sale or business management software that offers exportation of numeric figures or data such that the figures or data may be automatically uploaded to the system of the present invention on a pre-defined periodic basis.

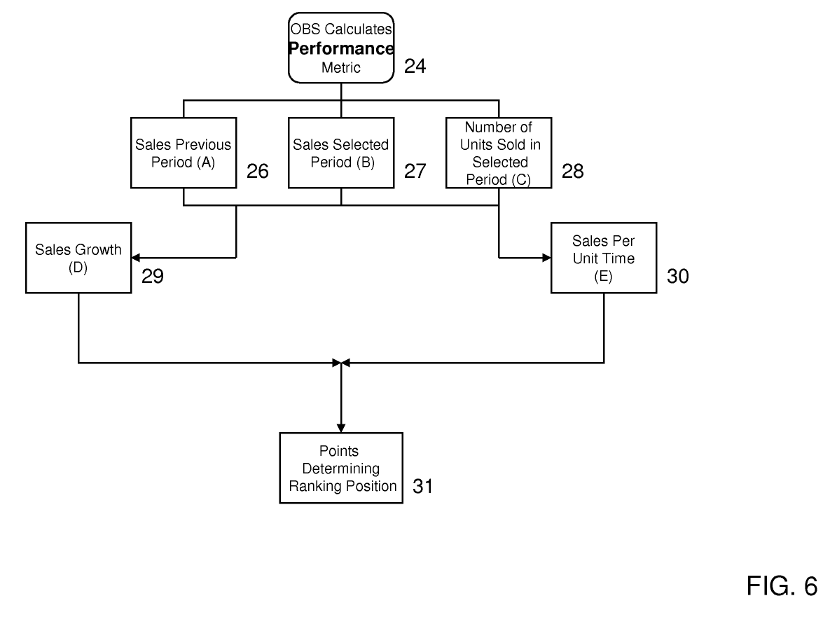

A number of meaningful and useful metrics, which are representative of various aspects of the financial condition and operations of a business, are envisioned as being calculated or determined by the system and method of the present invention using specific mathematical algorithms. These specific mathematical algorithms are maintained as the confidential trade secret information of the inventor of the present invention. At least four main metrics are calculated or determined for every type of business. These metrics are referred to herein as “Performance,” “Productivity,” “Profit” and “Pleasure (Customer Satisfaction).” Although each of these metrics are somewhat intertwined and consequently impact one another, each metric is ultimately represented by a separate number or a number of points that is used to determine the overall ranking position of the user's business. In calculating or determining each metric, at least two key indicators based upon the quantifiable figures or data supplied by the user are combined through one or more specific mathematical algorithms to calculate a number of points that will determine the ranking position within each of the four metrics. FIGS. 6 through 9 depict a first preferred embodiment of how each of the “Performance,” “Productivity,” “Profit” and “Pleasure (Customer Satisfaction)” metrics is determined.

In one exemplary embodiment, the “Performance” metric is generally based upon the sales of the business, how much revenue is being produced and how this revenue breaks down when regarded by a certain period of time and by unit sold. The “Performance” metric quantifies the output level of the operation in units sold (or the total amount of net revenue) and illustrates the growth percentage of the user's business in comparison to the same period in the previous year and how the business has performed in comparison with other similarly situated businesses of the same or related type. By monitoring the “Performance” metric, the user can visualize how to improve its sales performance by increasing the number of units sold or the revenue generated per unit. The number of units sold has to be maximized to an optimum level, with a corresponding pricing scale, until it reaches a degree where the physical and personnel capacity of the user's business limits any further growth or expansion.

As shown in FIG. 6, the “Performance” metric can, for example, be calculated or determined 24 by using three figures or data inputs supplied by the user. For example, given the amount of (A) revenue generated by the user's business during a previous period of time 26, (B) revenue generated by the user's business during a selected period of time 27, and (C) units sold during a selected period of time 28, two key indicators can be calculated and used to determine the ranking number or number of points 31 in the “Performance” metric. For example, those two key indicators can be the (D) sales growth 29 of the business over the selected period of time and the (E) revenue generated per unit sold 30 over the selected period of time.

With respect to the “Productivity” metric, in an exemplary embodiment, it is based upon relating the output produced, which can be measured by units sold or revenue generated, to the main resources available, such as the amount of space (i.e., the number of square meters or feet of different departments or areas of the business) and the number of personnel or employees. Due to the cost of real estate, this metric represents a major cost factor for any business. As the cost of space is normally measured in dollars per square foot (or square meter) per month, the “Productivity” metric provides, for example, a calculation of a business' monthly revenue in dollars per square foot or square meter (i.e., one unit area), which can be compared against other businesses of similar sizes. With respect to the number of personnel, as employees are paid on a periodic basis (e.g., weekly), the “Productivity” metric provides, for example, a calculation of a business' weekly revenue per employee. By being able to compare this figure with other businesses that have a similar number of employees, a business can determine how well it is generating revenue with its existing team of employees. Only the businesses with the most efficient use of space and personnel will achieve higher ranking positions.

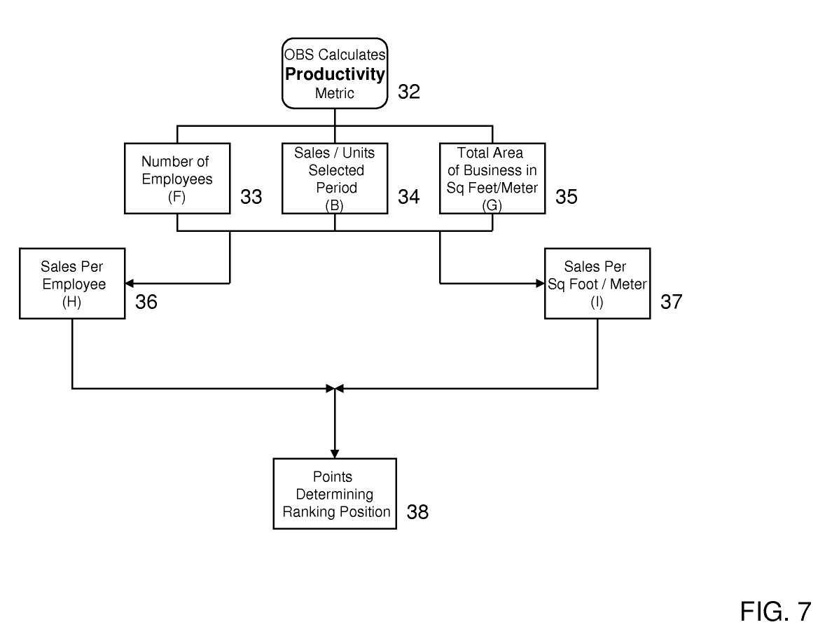

As shown in FIG. 7, the “Productivity” metric can, for example, be calculated or determined 32 by using three figures or data inputs supplied by the user. For example, given the (F) number of employees employed by the user's business during a selected period of time 33, (B) amount of revenue generated by the user's business per unit during the selected period of time 34, and (G) total amount of space owned or leased by the user's business (in square feet or square meters) during the selected period of time 35, two key indicators can be calculated and used to determine the ranking number or number of points 38 in the “Performance” metric. For example, those two key indicators can be the (H) amount of revenue generated per employee 36 during the selected period of time and the (I) revenue generated per unit of space 37 during the selected period of time.

The “Profit” metric is generally based upon the gross margin or percentage of a business, which is typically determined by the difference between the cost of sale over a given period and the net revenue generated during that same period. In order to minimize confidentiality issues, reduce complexity and to ensure a clear perspective as to what is needed for solid profitability, the “Profit” metric is preferably not calculated based on net margins nor final earnings before taxes, but rather, concentrates on gross margin percentages and inventory turn rates. Therefore, the “Profit” metric indicates whether a business is generating enough of a margin to be profitable and to be able to cover its operating expenses (e.g., the rent for its leased space, the payroll of its employees, marketing expenses, utilities, insurance, etc.). By monitoring the “Profit” metric, a business should be able to reliably and easily make the critical determination of how many sales within a certain period of time (for example, in volume of units per day) are needed in order to cover the business' expenses and costs of operating to break even. Furthermore, the “Profit” metric further signals the velocity in which the working capital of a business is turned over. Working capital is mainly bound in inventories of supplies. That is why each business must have a clear understanding of how much cash is bound by its inventory and how quickly it rotates. By determining the average inventory level as it relates to the number of sales made in a given period of time (e.g., a yearly quarter), a business can determine the rate at which its inventory is being turned. Preferably, this indication is provided in days of supply.

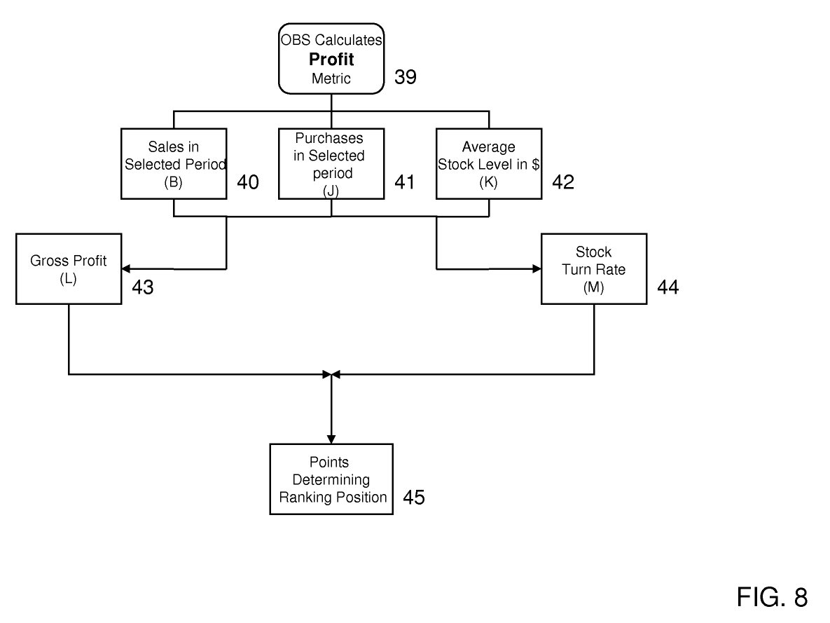

As shown in FIG. 8, the “Profit” metric can, for example, be calculated or determined 39 by using three figures or data inputs supplied by the user. For example, given the (B) amount of revenue generated by the user's business during a selected period of time 40, (J) number of purchases (or sales) made during a selected period of time 41, and (K) the average inventory level (in dollars) over the selected period of time 42, two key indicators can be calculated and used to determine the ranking number or number of points 45 in the “Profit” metric. For example, those two key indicators can be the (L) gross profit 43 of the user's business over the selected period of time and the (M) inventory turn rate 44 over the selected period of time.

The “Pleasure (Customer Satisfaction)” metric is generally based upon feedback received from customers regarding the quality of the services rendered and/or the quality of the products sold by a business. In order to provide numerical and quantifiable data that can be objectively used to calculate this metric, a business may gauge consumer opinion by, for example, providing a survey to all or a certain number of its customers and simply tally the number of survey responses that indicate satisfaction and the number of survey responses that indicate dissatisfaction. Thus, the positive and/or negative responses from the customers will preferably be automatically reflected through the “Pleasure (Customer Satisfaction)” metric as a percentage of satisfied customers. As a result, because this metric can be expressed as a percent of the number of satisfied customers against the number of total survey responses, it is perfectly comparable with other similarly situated business of the same or related type.

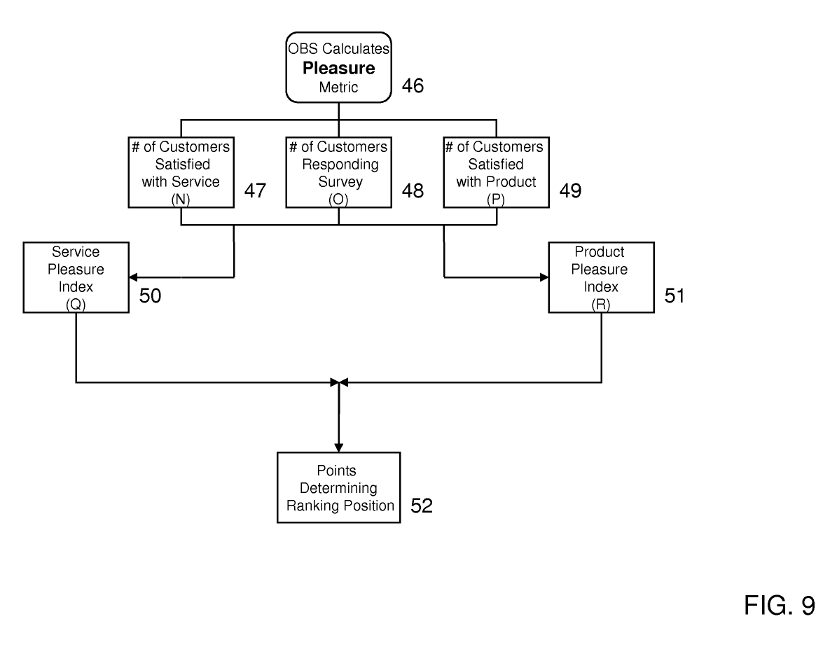

As shown in FIG. 9, the “Pleasure (Customer Satisfaction)” metric can, for example, be calculated or determined 46 by using three figures or data inputs supplied by the user's business that are based upon customer responses to satisfaction surveys. For example, given the number of (0) customers that responded to the survey 48, (N) customers that indicated they were satisfied with the quality of the service rendered by the user's business 47, and (P) customers that indicated they were satisfied with the quality of the product sold by the user's business 49, two key indicators can be calculated and used to determine the ranking number or number of points 52 in the “Pleasure (Customer Satisfaction)” metric. For example, those two key indicators can be referred to as the (Q) “Service Pleasure Index” 50 and the (R) “Product Pleasure Index” 51 and each index indicates, in the exemplary embodiment, the percentage of customers who are satisfied with the service rendered and the product sold by the user's business. This calculation of the “Pleasure (Customer Satisfaction)” metric can be used, for example, by a restaurant to evaluate both the success of its dining services and the taste of its food.

The four metrics discussed above are only intended to be illustrative of the types of metrics that are envisioned by the system and method of the present invention and are, the main four metrics that are determined for each type of business that utilizes the present invention. In alternative embodiments, the system and method of the present invention will also calculate other metrics to evaluate the businesses but these will not necessarily be taken into account when determining a ranking and they will vary by industry.

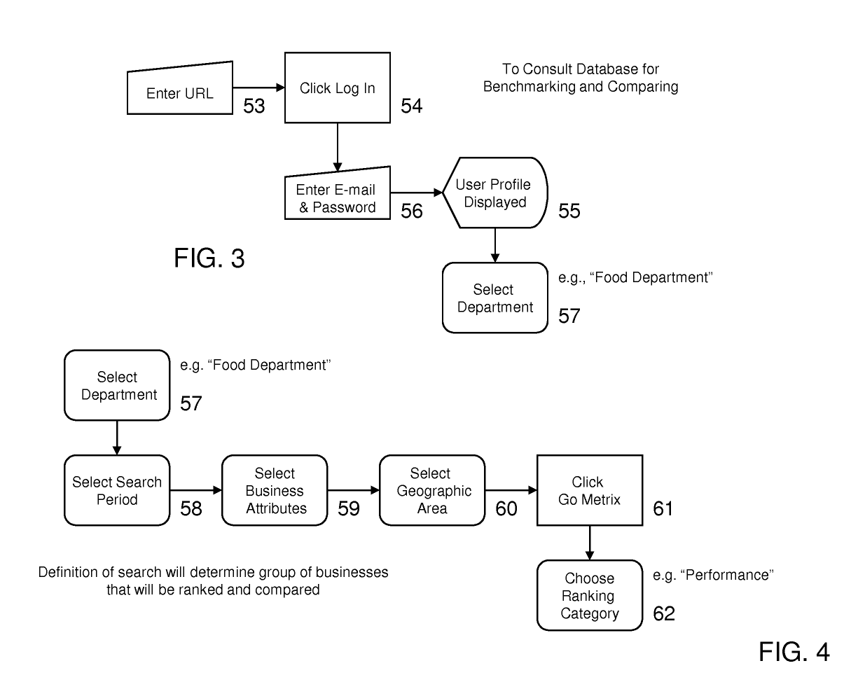

Once the user has entered all of the relevant figures or data into the system, the user can view how the user's business is performing under the various metrics over a specific period of time by consulting the one or more databases and initiating a search to determine how well the business is performing in comparison to other similarly situated businesses of the same or related type. FIGS. 3 through 5 illustrate a first preferred embodiment of how a user may access and query the system and method of the present invention in order to visualize the figures or data and the rankings under the various metrics in a series of benchmarking comparison tables such that the information can be digested by the user in a meaningful and useful way. Referring to FIGS. 3 and 4, the user enters the website or portal, for example, by going to the website's URL address 53, and, as previously described, uses the user's identification code and password 56 that was set during the registration process in order to gain access to the system 54 (e.g., “CLICK LOG IN”). Upon successful authentication and entry into the system, the user's profile and a data entry screen are displayed 55 and the user is provided with a list or menu of business departments 57. From the list or menu, the user selects the appropriate business department that correlates to the user's business in order to begin defining the parameters of the benchmarking comparison tables that the user would like to view. Thereafter, the user specifies the desired time period 58 over which the user would like to view the results (e.g., the 2^{nd} quarter of the year 2008).

After selecting the appropriate business department 57 and the relevant time period 58, a “SEARCH AND COMPARE” screen is displayed that allows the user to further define specific attributes 59 or filters of the types of businesses the user would like to be included in the benchmarking comparison tables. For example, if the user's business is a restaurant, and therefore, the user has specified that it would like to see comparison benchmarking tables that only include businesses falling within the “Food Department” category, the user may then be able to further define the characteristics of the businesses that are to be included in the tables by, for example, size (e.g., by yearly revenue), kitchen type, type of cuisine, and restaurant concept. The user may also be able to specify the geographical location 60, for example, the city and state of the businesses that should be included in the benchmarking comparison tables. In contrast to existing ratings systems, because the user has the ability to determine, with a large degree of specificity, the portion of the marketplace in which it competes, the rankings associated with the user's business and the basis for the comparison will be highly relevant and useful for the user.

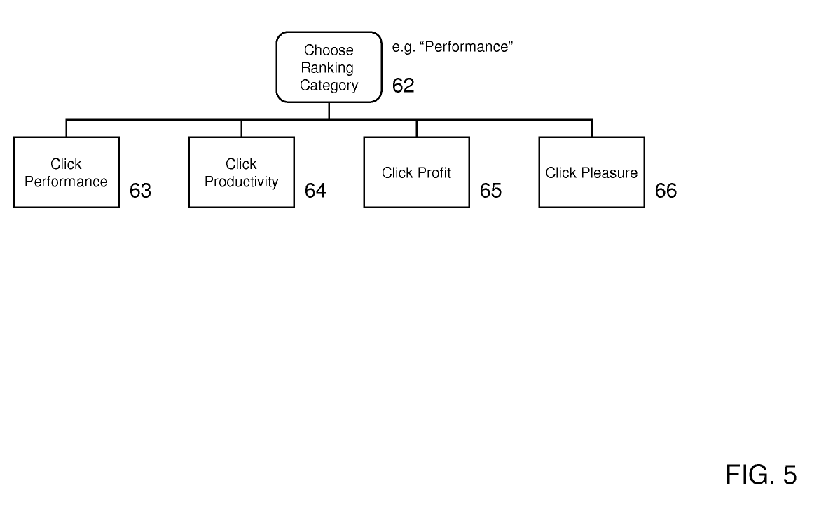

Once the user sets the search and comparison parameters, the user prompts the system 61 (e.g., “CLICK GO METRIX”) to display the benchmarking comparison tables according to the specified parameters. The results of the search are, in the exemplary embodiment, generated and displayed across a series of benchmarking comparison tables whereby each table correlates to a single metric. For example, in the exemplary embodiment shown in FIG. 5, the user may view tables corresponding to the four main metrics of “Performance,” “Productivity,” “Profit” and “Pleasure (Customer Satisfaction)” 63, 64, 65 and 66.

As the user selects 62 which metric to view, the corresponding benchmarking table is displayed. Each benchmarking table is comprised of a series of rows and columns whereby each row is associated with a single registered business, including the user's business, and each column is associated with a particular data figure that is relevant to the metric of the table. In this exemplary embodiment, the rows are hierarchically organized such that the business with the highest ranking is listed first, at the top of the table, and the business with the lowest ranking is listed last at the bottom of the table. Preferably, at the bottom of each column, the system indicates the average value of the data figure of that particular column amongst the group of businesses that are being compared in the table and a recommended benchmark value that is determined by the system administrator after analyzing and evaluating the results of the top performers in the industry. Therefore, the user can compare its numbers to the average and benchmark values to specifically determine what areas it needs to adjust or improve in its operations to obtain a higher metric ranking.

An example of a preferred embodiment of a benchmarking comparison table in accordance with the system and method of the present invention, as it would appear before the user, and corresponding to the “Performance” metric is shown in TABLE 1 below:

TABLE 1

| | | Sales | No. of | Sales | Meals/ | Meals/ | Revenue/ | |
|---|---|---|---|---|---|---|---|---|
| Nickname | Rank | Revenue | Meals | Growth | week | Day | Meal | Ranking |
| Gastro2 | 1 | $118,000 | 14500 | 136% | 1845 | 264 | $8 | 19.21 |
| Gastrox | 2 | $9,000 | 1000 | 17% | 318 | 45 | $9 | 10.52 |
| angie | 3 | $90,000 | 43000 | −64% | 5190 | 741 | $2 | 0.75 |
| Average | — | $72,333 | 19500 | 30% | 2451 | 350 | $4 | |
| Benchmark | | | | 30 | 300 | 50 | 20 | |

In TABLE 1, three similarly situated restaurants with the anonymous aliases or “nicknames” of “Gastro2,” “Gastrox” and “angie” are being compared based upon their “Performance” ranking that has been determined by the system and method of the present invention and is based upon the numerical figures or data that was provided by each of the restaurants. This group of restaurants corresponds to the search parameters that were set by the user. The first column is comprised of the aliases or “nicknames” of the three restaurants. The second column is comprised of the overall rank of the three restaurants as measured across the one or more metrics that have been determined by the system. The third and fourth columns are comprised of figures or data compiled over a specific period of time and provided by the restaurants. For example, as shown in TABLE 1, the third column is comprised of the amount of revenue generated during the time period and the fourth column is comprised of the number of meals sold during the time period. The fifth, sixth, seventh and eighth columns are comprised of indicators mathematically calculated and determined by the system and based upon the figures or data provided by the restaurants. For example, as shown in TABLE 1, the fifth column is comprised of the percentage sales growth of the restaurant during the time period. The sixth column is comprised of the number of meals sold per week during the time period. The seventh column is comprised of the number of meals sold per day during the time period. The eighth column is comprised of the amount of revenue generated per meal during the time period. The ninth column is comprised of each restaurant's ranking number or number of points under the “Performance” metric as based upon the indicators and is mathematically calculated and determined by the system. Below each of the columns that are comprised of the indicator values (i.e., the fifth, sixth, seventh and eighth columns), the system also provides an average value of that indicator amongst the group of restaurants being compared in the table and a recommended benchmark value for that indicator.

In addition, the user is able to give an explanation or definition of the figures or data values that appear in each column of the table so that the user may further understand the significance of each number shown in the table. For example, in an exemplary embodiment depicted below in TABLE 2, that is in accordance with the system and method of the present invention, the user is able to view dialog boxes that contain a brief explanation of what each column is depicting in the table simply by scrolling over the column heading. For example, in TABLE 2, the “Sales Revenue” column is described in a dialog box as “To date sales revenue in current quarter. Volume of output measured in $.”

TABLE 2

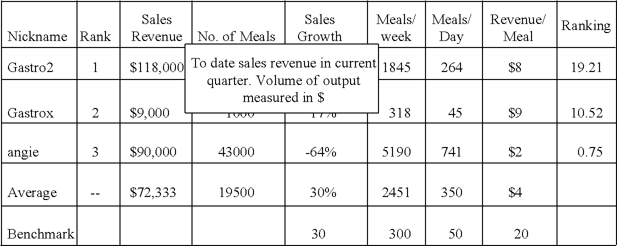

Furthermore, the system and method of the present invention can provide further consulting information than just defining a number of highly relevant and useful metric ratings by which a business may perform a self-evaluation and compare its results to other similarly situated businesses of the same or related type and displaying the results in a meaningful way in a series of benchmarking comparison tables. Due to the anonymous nature of the system whereby users may keep confidential the identity of their business from the other users, the competitive nature between specific companies or businesses is greatly reduced and the free-flow of information is not hindered by the desire to keep sensitive information secret. Therefore, a “business-to-business” community can be encouraged and formed using the present invention. For example, a discussion forum or other methods of communication between the users of the system may be integrated into the system for users to exchange useful information on how to improve their business operations. The system itself may also provide users with helpful tips or further information to aid the improvement of their business operations. For example, as shown below in TABLE 3, dialog boxes may appear as the user scrolls over the various data fields or columns of the benchmarking comparison tables. The dialog boxes contain helpful comments or suggestions from other users or from the system itself that are relevant to the particular data field or column that is proximal to the dialog box.

TABLE 3

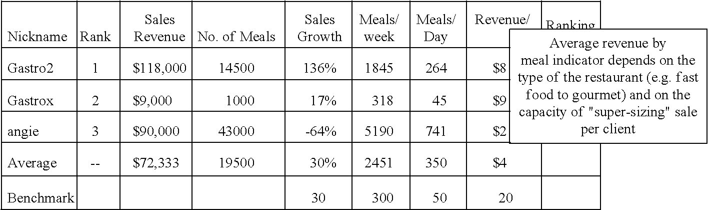

The user will periodically enter new data and perform the same evaluation above in order to gauge whether or not the user's business performance and operations have improved relative to the other businesses within the comparison group in response to implementing new and, most likely, better business practices than before. Each time the user periodically enters new data and the data is saved in the system, the metrics are automatically calculated and reflected in the benchmarking comparison tables.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A system for evaluating and comparing businesses, comprising:
an Internet-accessible portal having a user-interface wherein the portal is in communication with at least one database;
one or more data figures that reflect the operations of a user's business wherein the one or more data figures are entered into the portal by the user and are stored in the at least one database;
one or more metrics wherein the one or more metrics are calculated based upon the one or more data figures and are indicative of the user's business operations;
a group of one or more businesses similarly situated to the user's business as defined by the user wherein the metrics of the one or more businesses are known and have been stored in the at least one database;
wherein a metric ranking number is assigned to the user's business and to the one or more businesses of the group based upon their respective metrics; and
wherein the metric ranking numbers of the user's business and the one or more businesses of the group are displayed in a format wherein their respective metrics can be compared against one another.

2. The system of claim 1, wherein the user enters the one or more data figures on a periodic basis.

3. The system of claim 1, wherein the one or more data figures reflect the revenue, number of units sold, amount of inventory, physical dimensions, and number of employees of the user's business during a period of time.

4. The system of claim 1, wherein the identities of the user's business and the one or more businesses of the group are kept anonymous from one another.

5. The system of claim 1, wherein at least one of the metrics is indicative of the performance during a period of time of the business about which the metric is calculated.

6. The system of claim 1, wherein at least one of the metrics is indicative of the productivity during a period of time of the business about which the metric is calculated.

7. The system of claim 1, wherein at least one of the metrics is indicative of the profitability during a period of time of the business about which the metric is calculated.

8. The system of claim 1, wherein at least one of the metrics is indicative of the customer satisfaction during a period of time with the business about which the metric is calculated.

9. The system of claim 1, wherein the one or more metrics are dependent upon the type of business about which the metric is calculated.

10. The system of claim 1, wherein the format of displaying the metric ranking numbers is a series of one or more comparison tables.

11. The system of claim 10, wherein each of the one or more comparison tables in the series corresponds to a metric.

12. The system of claim 11, wherein the one or more data figures relied upon to calculate the metric is also displayed in the comparison table.

13. The system of claim 2, wherein the one or more metrics are calculated after each period that the user enters the one or more data figures.

14. The system of claim 1, wherein the user defines the group of the one or more businesses based upon one or more characteristics that include the type of business department, physical size, inventory size, number of employees and geographical location of the one or more businesses.

15. The system of claim 1, wherein the user specifies a period of time over which the calculation of the one or more metrics is to reflect.

16. The system of claim 10, wherein the one or more comparison tables further comprises information that explains the definition and meaning of what is displayed in the one or more comparison tables.

17. The system of claim 10, wherein the one or more comparison tables further comprises average or benchmark levels of the one or more metrics against which the user may compare the corresponding one or more metrics of the user's business.

18. The system of claim 1, further comprising a means for the user and the one or more businesses of the group to anonymously communicate directly.

19. A method for evaluating and comparing businesses, comprising:
inputting into an Internet-accessible portal one or more data figures that reflect the operations of a user's business wherein the portal has a user-interface;
storing the one or more data figures in at least one database that is in communication with the portal;
calculating one or more metrics that are based upon the one or more data figures and are indicative of the user's business operations;
defining a group of one or more businesses that are similarly situated to the user's business and of which the one or more metrics are known and have been stored in the at least one database;
assigning a metric ranking number to the user's business and to the one or more businesses of the group based upon their respective metrics; and
displaying the metric ranking numbers of the user's business and the one or more businesses of the group in a format wherein their respective metrics can be compared against one another.

20. A method for evaluating and comparing businesses, comprising:
inputting into an Internet-accessible portal one or more data figures that reflect the operations of a user's business wherein the portal has a user-interface;
storing the one or more data figures in at least one database that is in communication with the portal;
calculating a plurality of metrics that are based upon the one or more data figures and are indicative of the user's business operations wherein at least one of the metrics is indicative of the performance, productivity, profitability and customer satisfaction during a period of time of the business about which the metric is calculated;
defining a group of one or more businesses that are similarly situated to the user's business and of which the metrics are known and have been stored in the at least one database;
assigning a metric ranking number to the user's business and to the one or more businesses of the group based upon their respective metrics; and
displaying the metric ranking numbers of the user's business and the one or more businesses of the group in a series of one or more comparison tables wherein their respective metrics can be compared against one another wherein the identities of the user's business and the one or more businesses of the group are kept anonymous from one another.
